(19) United States
(12) Patent Application Publication
(10) Pub. No.: US 2020/0317046 A1
(43) Pub. Date: Oct. 8, 2020

(54) A DIFFERENTIAL

(71) Applicant: QINETIQ LIMITED, Hampshire (GB)

(72) Inventor: Robert John Bonner FLAXMAN, Guildford, Surrey (GB)

(21) Appl. No.: 16/303,111

(22) PCT Filed: Mar. 16, 2017
(86) PCT No.: PCT/EP2017/056313

§ 371 Date: Nov. 19, 2018

(30) Foreign Application Priority Data
May 18, 2016 (GB) 1608753.8

(51) Int. Cl. B60K 17/16; B60K 23/04

(52) U.S. Cl. CPC B60K 17/16; B60K 23/04; B60Y 2400/73; B60L 2240/423; B60K 2023/043

(57) ABSTRACT

Some embodiments are directed to a differential including: a left-side planetary gear set having a sun gear configured to receive rotational drive input from a drive source, a ring gear in a torque connection with an electric motor and a carrier gear configured to be operatively coupled with a left-side vehicle drive member in a torque connection; a right-side planetary gear set having a sun gear configured to receive rotational drive input from the drive source, a ring gear in a torque connection with the electric motor and a carrier gear configured to be operatively coupled with a right-side vehicle drive member in a torque connection; wherein the sun gears of the left and right side planetary gear sets are rotationally fixed relative to each other and, in use, the amount of power transferred between the drive source and each of the respective drive members can be selectively controlled.

### CROSS REFERENCE TO RELATED APPLICATION(S)

This application is a national phase filing under 35 C.F.R. § 371 of and claims priority to PCT Patent Application No. PCT/EP2017/056313, filed on Mar. 16, 2017, which claims the priority benefit under 35 U.S.C. § 119 of British Patent Application No. 1608753.8, filed on May 18, 2016, the contents of each of which are hereby incorporated in their entireties by reference.

### GOVERNMENT LICENSE RIGHTS

This invention was made with Government support under Contract No. W56HZV-11-C-Cool awarded by the United States Army. The Government has certain rights in this invention.

### BACKGROUND

Some embodiments relate to a differential for a vehicle, in particular a wheeled or tracked vehicle, which can be operated to provide traction control or cause skid steering.

A differential gear is used to allow torque and power to be transferred from single input source to two outputs rotating at different speeds. A typical related art differential lay-out is shown in FIG. 1.

An engine and transmission output 1a (with small generator 1b) provide a single input to the differential gear 2. The two wheel half-shafts 3, 4 driving the rear wheels are the output of the differential 2. The engine and transmission output 1 operatively connects with the differential 2 through a pair of bevel gears 5, 5′. The entire differential assembly rotates at the speed of the large bevel gear 5′.

When driving in a straight line, the output torque and speed on the left and right sides is the same. During a turn the outside wheel will turn faster than the inside wheel. The arrangement of bevel gears 6a to 6d inside the differential 2 allows the left and right sides to rotate at different speeds whilst still keeping the output torque on each side the same. The differential 2 allows the same torque output on each side yet allows each side to turn at different speeds. Therefore, power to the outside wheel will be higher than the inside wheel. This is how a typical differential works.

### SUMMARY

The wheel torque on each side must be the same to maintain a constant speed difference between the left and right sides during a turn. If one wheel loses traction and the other side does not, then the side that lost traction will not be able to sustain a torque and therefore it will accelerate up to a high speed, diverting too much power to the spinning wheel.

Limited slip differentials are used to impede or prevent excessive power from being allocated to one wheel in order to keep both wheels in powered rotation. A limited slip differential limits the speed difference between the two wheels so that if one wheel starts to spin excessively then more torque is transferred to the side with higher traction.

It may therefore be beneficial to provide an enhanced differential.

Some embodiments are directed to a differential including:
a left-side planetary gear set having a sun gear configured to receive rotational drive input from a drive source, a ring gear in a torque connection with an electric motor and a carrier gear configured to be operatively coupled with a left-side vehicle drive member in a torque connection;
a right-side planetary gear set having a sun gear configured to receive rotational drive input from the drive source, a ring gear in a torque connection with the electric motor and a carrier gear configured to be operatively coupled with a right-side vehicle drive member in a torque connection;
wherein the sun gears of the left and right side planetary gear sets are rotationally fixed relative to each other;
and wherein the torque connection of the respective ring gears to the electric motor only permits rotation of the ring gears relative to one another in an equal and opposite sense, which rotation may be free or selectively powered by the electric motor.

The present arrangement of differential and motor allows for the transfer of power from the inside wheel to the outside wheel which is the result of skid steering. It should be noted that the power transferred across the differential can be greater than the power input from the engine.

Such a differential can thus be operated as a limited slip differential and, advantageously, can also be operated to cause skid steering. This offers a more cost effective solution where a conventional drive-line (engine and transmission) could be used directly to provide propulsion to a vehicle, with traction control and steering provided using an electric motor (controlling the torque output to the respective left and right drive members).

The drive source will usually include an engine, such as an engine and transmission, with a generator attached to the engine (e.g. larger than normal) to provide the requisite power to the electric motor. The sun gears may be fixedly rotationally coupled relative to one another by a common shaft between them, which may be driven by a drive shaft of the drive source via a gear arrangement such as a bevel gear arrangement.

The respective (back to back) ring gears may each be in a torque connection with the electric motor via a common bevel gear (orthogonally positioned between them), rotation of which bevel gear causes equal and opposite rotation of the respective ring gears disposed between them. The bevel gear may be operatively coupled to the electric motor via a gear reduction stage. The operative coupling may include a third planetary (epicyclic) gear set.

Alternatively, the respective ring gears may each be in a torque connection with the electric motor via a series of spur gears arranged between them, which also cause equal and opposite rotation of the respective ring gears.

A control system may be provided to selectively control the amount of power transferred between the drive source and each of the respective drive members.

The control system may be configured to allow operation in some or usually all of the following operational modes:
i) A mode, for example when straight line driving, in which the electric motor is de-energised and the ring gears do not rotate (e.g. and the common bevel gear does not rotate);
ii) A mode, for example when turning, in which the electric motor is de-energised and the ring gears rotate (freely) in an equal and opposite manner through the common bevel gear, thereby acting as a normal differential;
iii) A mode, for example when traction is lost during straight line driving, in which the electric motor is energised to provide a holding torque (locking the bevel gear) so as to impede or prevent any relative rotation of the ring gears; and,
iv) A mode, for example when turning when traction is lost, in which the electric motor is energized and the rings gears rotate in an equal and opposite manner through the common bevel gear, the electric motor selectively driving the bevel gear either clockwise or anti-clockwise to deliver torque as required to balance power flows to the wheels
v) A mode, for example, when skid-steering is required while turning and moving forwards or backwards, in which the electric motor is selectively energized to apply torque and speed in an equal and opposite manner through the common bevel gear either clockwise or anti-clockwise to impart a sufficient torque difference between the two output half-shafts to allow the inside wheel to transfer regenerative braking power into the differential via the inside half-shaft and with propulsion power from the engine and power from the electric motor will drive the outside wheel via the outside half shaft to enable a skid-steer turn;
vi) A mode, for example, when driving forward or backwards, on a side-slope, in which the electric motor can be selectively energized to apply a holding torque in an equal and opposite manner via the common bevel gear, to provide more torque to the wheel on the downward side of the vehicle and less torque to the wheel on the upward side of the vehicle to allow it drive in a straight line;
vii) A mode, for example, when skid-steering about the vehicle neutral axis such as a pivot turn, in which the electric motor is selectively energized to apply torque and speed in an equal and opposite manner through the common bevel gear either clockwise or anti-clockwise to impart a torque and speed difference at the left and right half-shafts to allow the wheels to turn in an equal and opposite manner either in a clockwise or anti-clockwise manner.

Some other embodiments are directed to a differential including:
a left-side planetary gear set having a sun gear configured to receive rotational drive input from a drive source, a ring gear in a torque connection with an electric motor and a carrier gear configured to be operatively coupled with a left-side vehicle drive member in a torque connection;
a right-side planetary gear set having a sun gear configured to receive rotational drive input from the drive source, a ring gear in a torque connection with the electric motor and a carrier gear configured to be operatively coupled with a right-side vehicle drive member in a torque connection;
wherein the sun gears of the left and right side planetary gear sets are rotationally fixed relative to each other and, in use, the amount of power transferred between the drive source and each of the respective drive members can be selectively controlled by operating the electric motor to drive or apply torque to the ring gears in opposite directions.

Some other embodiments provide a vehicle including a differential as described above.

### BRIEF DESCRIPTION OF THE DRAWINGS

Some embodiments will now be described by way of non-limiting example with reference to the accompanying drawings, in which:

FIG. 1 is a schematic drawing of a related art differential;

FIG. 2 is a schematic drawing of a differential according to an embodiment.

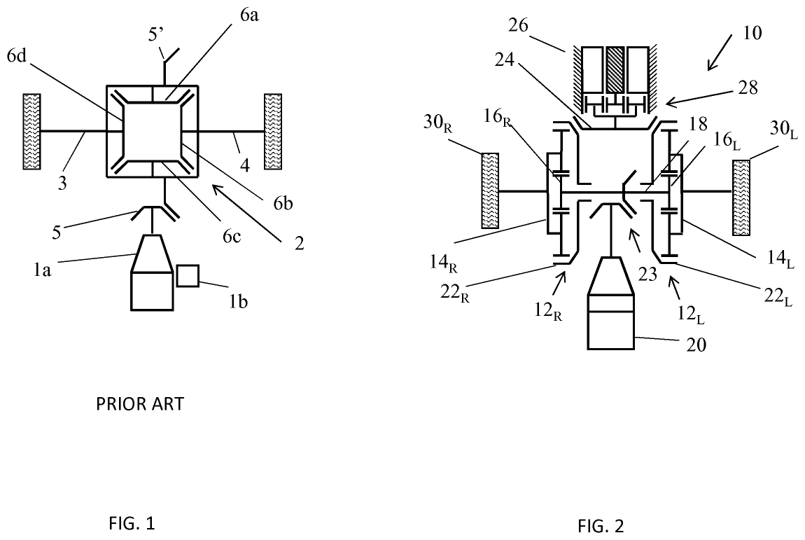

### DETAILED DESCRIPTION OF EXEMPLARY EMBODIMENTS

Some aspects and embodiments of the presently disclosed subject matter concern a type of limited slip differential which includes an electric motor to control the torque output to each of the left and right sides.

An electric motor assisted differential system is illustrated in FIG. 2, which represents a rear wheel drive vehicle with engine at the front (bottom of page) and differential 10 at the back between the two rear wheels 30_{L}, 30_{R}. Limited Ackerman steering may be achieved by the front two wheels (not shown).

The differential 10 has two planetary gear sets 12_{L}, 12_{R} arranged back-to-back. The left and right outputs of the differential 10 are the left and right carriers 14_{L}, 14_{R} with a common sun 16_{L}, 16_{R} as the drive input. Moreover, the sun gears 16_{L}, 16_{R} of the two planetary gear sets 12_{L}, 12_{R} are connected by a cross shaft 18, which is operatively coupled to a drive source 20 (i.e. features up stream in the vehicle powertrain such as a combustion engine, electric motor/generator and transmission etc.) through a bevel gear arrangement 23. The left and right ring gears 22_{L}, 22_{R} mesh with an additional bevel gear 24 that is operatively connected to an electric motor 26 of the differential 10. FIG. 2 shows that the bevel gear 24 is operatively connected to the (traction assisting) electric motor 26 via an additional gear reduction stage 28 (another planetary gear set) but this is not essential.

During straight-line driving with the electric motor 26 de-energised, the left and right carriers 14_{L}, 14_{R} output the same speed and torque. As such the torques exerted on the respective rings gears 22_{L}, 22_{R} are similar, providing that respective torques exerted thereby on the bevel gear 24 are equal and opposite so that both it and the ring gears 22_{L}, 22_{R} themselves do not turn.

During a turn to the right however with the electric motor de-energised, the left carrier 14_{L} attached to the outside wheel will turn faster than the right carrier 14_{R} attached to the inside wheel. With the bevel gear arrangement 23 driving the cross-shaft 18, the unit will behave as a normal differential. The torque will equally be applied to sun gears 16_{L}, 16_{R} and the torques exerted on the bevel gear 24 by the ring gears 22_{L}, 22_{R} will be equal and opposite and the bevel gear 24 will be free to rotate at the resultant speed. With the electric motor 26 de-energised its rotor will turn with the bevel gear 24 and the torque on the left and right sides of the differential 10 will balance such that it behaves as a typical differential.

If one of the wheels loses traction during straight-line driving, then in a typical differential the side that lost traction will begin to spin excessively. The present embodiment can address this by energising the electric motor 26 to provide a holding torque to balance the torque on the side that lost traction. Therefore, in such a situation, all the drive torque can be delivered to the side with traction to maintain all possible traction. By controlling the output torque from the electric motor 26, the torque output from the engine and transmission 20 to cross-shaft 18 (and sun gears 16_{L} and 16_{R}) can be directed to either output carrier 14_{L} or output carrier 14_{R} or both.

If one of the wheels loses traction during a clock-wise turn with the electric motor 26 energised the carrier 14_{L} attached to the outside wheel will turn faster than the carrier 14_{R} attached to the inside wheel. The ring gears 22_{L}, 22_{R} can be caused to turn in opposite directions at equal speeds upon energising the motor 26. The electric motor 26 will turn with the bevel gear 24 and can thus deliver torque as required to direct the power flow to the wheels. An anti-clockwise turn will operate in the opposite sense.

The differential 10 can also be used for skid-steering if desired.

A skid steered wheeled or tracked vehicle can be steered by forcing wheels or tracks on one side of the vehicle to run at different speeds to the wheels/tracks on the other side of the vehicle. For example, for tracked vehicles to steer, large driving force differences are required between tracks on opposite sides of the vehicle i.e. large braking torques on the inner tracks and high driving torques on the outer tracks. In the currently disclosed subject matter, differential gears and cross-shafts are used to control the relative speeds of the tracks and transfer the braking power from the inner track to the outer track to sustain the turn. Steering powers can be 3 to 4 times higher than powers for straight-line driving.

The control of the electric motor 26 will allow the mechanical transfer of the large regenerative torque and power (i.e. braking torque and power) from the inside wheel (or sprocket) to the outside wheel (or sprocket) through the differential. Therefore, the large skid-steering powers required for turning can be obtained from a compact (steer) motor 26 and differential coupled to a much smaller engine and transmission propulsion system 20.

The differential 10 can be used to control the relative speeds of opposing wheels and transfer the braking power from the inner wheel to the outer wheel to sustain the turn.

A vehicle traversing in a straight-line on a side-slope will require more torque on the wheel on the downward side and less torque in the wheel on the upward side. The traction assisting motor can be controlled to impart an equal and opposite holding torque which allows more torque to be added to the engine drive torque to the downward side wheel and allows torque to be subtracted from the engine drive torque to the upward side wheel while keeping the vehicle in a straight line.

Also, with the vehicle stopped (i.e. shaft 18 stationary), the traction assisting motor can impart equal and opposite torques and speeds at the wheels (or sprockets) causing the vehicle to pivot about its neutral axis (i.e. skid steer). A clockwise rotation of the vehicle is achieved by rotating the electric motor in one direction and an anti-clockwise rotation of the vehicle is achieved by rotating the electric motor in the opposite direction.

A similar arrangement to that described could be used for a skid steered tracked vehicle, whereby the wheels illustrated in FIG. 2 are replaced with sprockets for driving opposing tracks.

Power to drive the electric motor 26 could come from a larger generator attached to the engine 20.

It will be appreciated that whilst various aspects and embodiments of the presently disclosed subject matter have heretofore been described, the scope of the presently disclosed subject matter is not limited to the embodiments set out herein and instead extends to encompass all arrangements, and modifications and alterations thereto, which fall within the spirit and scope of the appended claims. In particular, whilst bevel gears are shown here for illustration, a spur gear differential could also be used to cause equal and opposite rotation of the ring gears.

1. A differential, comprising:
a left-side planetary gear set having a sun gear configured to receive rotational drive input from a drive source, a ring gear in a torque connection with an electric motor, and a carrier gear configured to be operatively coupled with a left-side vehicle drive member in a torque connection;
a right-side planetary gear set having a sun gear configured to receive rotational drive input from the drive source, a ring gear in a torque connection with the electric motor, and a carrier gear configured to be operatively coupled with a right-side vehicle drive member in a torque connection;
wherein the sun gears of the left and right side planetary gear sets are rotationally fixed relative to each other; and
wherein the torque connection of the respective ring gears to the electric motor only permits rotation of the ring gears relative to one another in an equal and opposite sense, which rotation may be free or selectively powered by the electric motor.

2. The differential according to claim 1, wherein the respective ring gears are in an torque connection with the electric motor via a common bevel gear, rotation of which causes equal and opposite rotation of the respective ring gears.

3. A vehicle, comprising:
the differential according to claim 1.

4. The vehicle of claim 3, wherein the vehicle drive members are wheels.

5. The vehicle of claim 3, wherein the vehicle drive members are sprockets for driving tracks on opposite sides of the vehicle.

6. A differential, comprising:
a left-side planetary gear set having a sun gear configured to receive rotational drive input from a drive source, a ring gear in a torque connection with an electric motor, and a carrier gear configured to be operatively coupled with a left-side vehicle drive member in a torque connection;
a right-side planetary gear set having a sun gear configured to receive rotational drive input from the drive source, a ring gear in a torque connection with the electric motor and, a carrier gear configured to be operatively coupled with a right-side vehicle drive member in a torque connection; and
wherein the sun gears of the left and right side planetary gear sets are rotationally fixed relative to each other and, in use, the amount of power transferred between the drive source and each of the respective drive members can be selectively controlled by operating the electric motor to drive or apply torque to the ring gears in opposite directions.

7. (canceled)

8. A vehicle, comprising:
the differential according to claim 2.
